(19) United States
(12) Patent Application Publication
(10) Pub. No.: US 2015/0086060 A1
(43) Pub. Date: Mar. 26, 2015

(54) Earphones with Built-In Splitter

(71) Applicant: Samuel H. Russ, Mobile, AL (US)

(72) Inventor: Samuel H. Russ, Mobile, AL (US)

(21) Appl. No.: 14/033,512

(22) Filed: Sep. 22, 2013

(51) Int. Cl. H04R 3/12; H04R 1/10

(52) U.S. Cl. CPC H04R 3/12; H04R 1/1091; H04R 2430/01; H04R 2420/09
USPC 381/384

(57) ABSTRACT

By combining an earphone with an extra audio splitter and jack, it becomes possible to share the audio being played over one set of earphones with another set of earphones in a sanitary manner using ordinary, unmodified earphones.

### BACKGROUND OF THE INVENTION

Earphones, also known as headphones or earbuds, are commonly used to listen to music or other audio media. They provide relative privacy in listening, permit others not to be bothered by the sound, consume relatively little power, and add portability.

One disadvantage of conventional earphones is that sharing of audio among multiple persons is difficult. The difficulty arises from their very purpose, to provide sound to one person without disturbing others. One common method, having the left and right earphone shared between two people, is unsanitary and therefore undesirable.

Another method is to purchase an earphone splitter. This requires one to purchase and carry around extra equipment and may not always be available. A similar method, described in WO 2008/086279 A2 to Gantz, is to provide a second set of earphones that can be stored in combination with a first set and optionally separated and used. This has the disadvantage of being forced to pay for and carry around a second set of earphones.

Another method is to add some sort of radio transmitter, but this requires the purchase not only of the transmitter but also of special earphones to receive the audio. A similar method, described in US 2013/0016849 A1 to Senemaud, is to have an external apparatus that combines two audio inputs and drive two sets of earphones. This also requires the purchase of special electronics.

It is desirable to add features to earphones to permit persons to share the audio among multiple earphones. The features should enable users of ordinary, unmodified earphones to hear the audio, and should not require the primary user to carry around extra earphones. Additionally the features should permit multiple persons to listen to the same audio without disturbing others and in a sanitary manner.

### BRIEF SUMMARY OF THE INVENTION

In the following, terms such as “earphones,” “headphones,” “headsets,” and “earbuds” are used synonymously to refer to portable audio devices usually placed in or near human ears. The term “plug” is used to describe the metal tip that carries audio signals (and the plastic casing adjacent to it that is used to hold it) and the term “jack” is used to describe the hole or receptacle that holds the plug (and the plastic casing surrounding it). This patent anticipates and therefore includes well-known variants of earphones, plugs, and jacks, including versions that are monaural and stereo, versions with and without microphones, and versions with various pin orderings.

In order to enable another set of earphones to listen to an audio source, an extra earphone jack and audio splitter are added to the earphones. This enables another set of earphones to attach and render the same audio for another listener. In an alternate embodiment, a source of power (such as a battery) and an audio amplifier are added to compensate for the extra load added by the extra set of earphones.

The extra jack permits ordinary, unmodified earphones to connect to the same audio source. By using an extra set of earphones, the arrangement is sanitary and the primary listener does not need to pay for or carry around the extra set of earphones.

### BRIEF DESCRIPTION OF THE SEVERAL VIEWS OF THE DRAWINGS

FIG. 1 is an illustration of the primary and secondary earphones and the jack-and-plug arrangement that permits the attachment of an extra set of earphones.

FIG. 2 is an alternate embodiment including a power source and amplifier.

FIG. 3 is an exemplary unity-gain circuit to add drive strength and drive multiple sets of earphones.

FIG. 4 is an exemplary amplifier circuit that adds volume control.

### DETAILED DESCRIPTION OF THE INVENTION

The following description is presented in order to enable persons of ordinary skill in the art to make and use the invention without undue experimentation. Various modifications to the disclosed embodiments will be readily apparent to persons of ordinary skill in the art, and the principles disclosed herein are applicable to other embodiments of the invention without departing from the spirit and scope of the present invention. Specifically, certain elements of the invention, such as the amplifier circuit, monaural/stereo earphones, presence or absence of a microphone, and arrangement of pins, are capable of numerous modifications and variations known to persons in the art. The invention explicitly discloses that there are numerous combinations of invention elements, and all combinations are therefore disclosed herein.

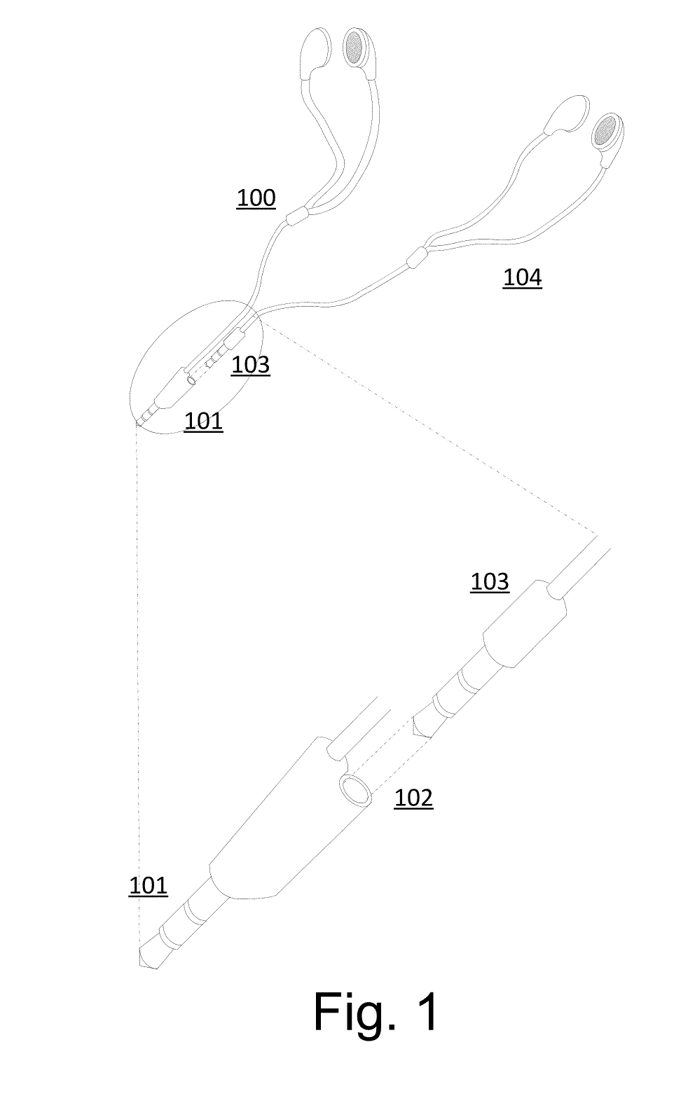

As shown in FIG. 1, a set of earphones 100 has a plug 101. This set of earphones is specially modified so that the plastic casing of plug 101 includes a jack 102 for receiving the plug of a different set of earphones. If no earphone plug is inserted into the jack 102, the earphones 100 operate normally. If an extra earphone plug 103 of second earphones 104 is inserted, both earphones 100 and earphones 104 present sound to their respective listeners.

The shape and size of the casing of jack 102 may vary, and the jack 102 may be located a distance up the cable away from plug 101 (in an embodiment not shown). The casing of jack 102 may be decorated or molded into a creative shape, such as the mouth of an animal, or may be plain and unmodified. The jack 102 may have a cover or door over it to prevent dust or dirt from accumulating when not in use. The jack 102 is of a design to accommodate the plugs of widely sold earphones. (The jack 102 is normally of the corresponding size and shape to, and will therefore mate with, plug 101.) One common size is the 3.5 mm phone jack widely used in smart phones such as those sold by Apple, Inc. of Cupertino, Calif.

More than one jack 102 may be added to earphones 100, so that more than one extra set of earphones can be optionally attached.

If the earphones that are attached to jack 102 are also modified with their own jack 102, additional earphones can be added. Conversely, the earphones that are attached to jack 102 need not be modified and can be ordinary, already existing, commercially sold earphones.

One disadvantage of this simple circuit is that the audio drops in amplitude (that is, loudness) as additional earphones are attached. This is because the audio energy (emitted by the device to which the earphones are attached) is being split among multiple earphones. This can be compensated by additional circuitry.

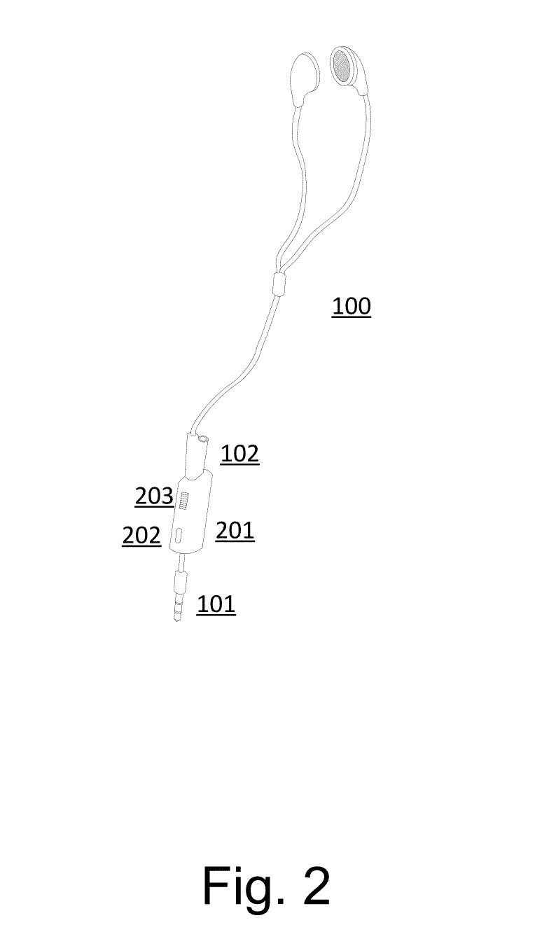

As shown in FIG. 2, the earphones 100 may include not only the plug 101 and jack 102 but also a casing 201 for an amplifier and power source. The power source may be a removable battery or rechargeable battery. If the battery is rechargeable, the casing 201 may have a port 202 for attaching a charger. The casing 201 may also include a volume control 203 such as a volume-control knob or button-operated controls. As before, the plug 101, jack 102, and casing 201 may be arranged and/or combined in any order and may be molded into decorative shapes.

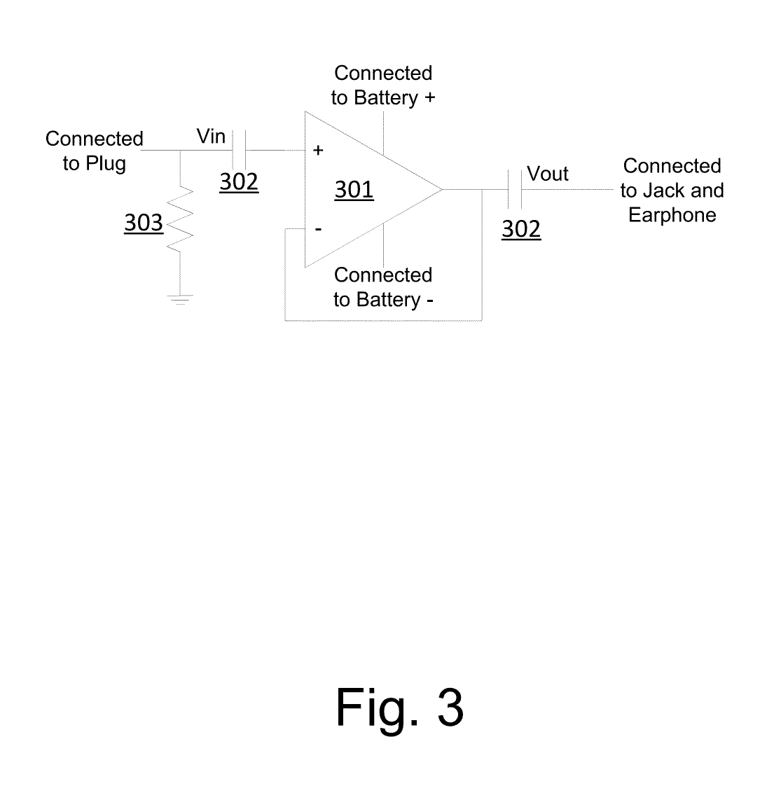

FIG. 3 shows an exemplary electronic amplifier circuit that may be contained in casing 201. This circuit uses an op-amp 301 in a well-known unity-gain configuration. Capacitors 302 may be used so that the DC op-amp circuit can drive the AC audio waveform. Resistor 303 may be needed so that the audio appliance to which the plug 101 is attached drives an ordinary, single headphone impedance. (For example, some headphones manufactured by Apple, Inc. of Cupertino, Calif. have an impedance of 23 ohms.) The use of capacitors 302 and resistor 303 are optional and their use depends on the design of the overall circuit. This particular circuit drives on its output the same voltage that it receives on its input, and the op-amp 301 adds drive strength, so that multiple earphones can be attached without loss of amplitude.

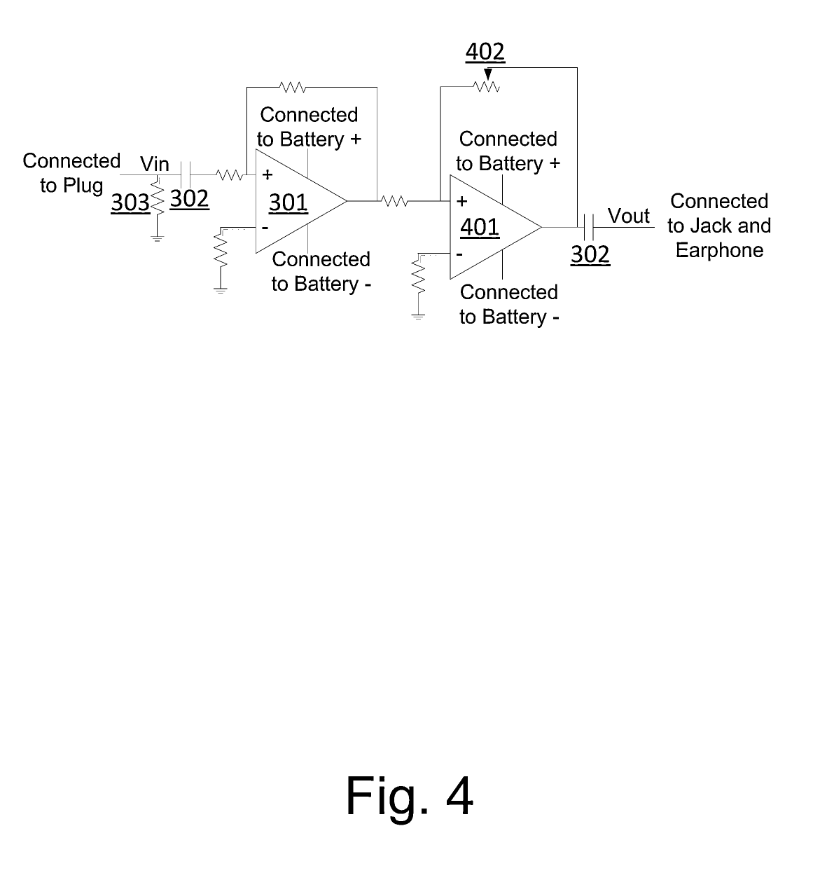

FIG. 4 shows another exemplary electronic circuit. In addition to op-amp 301, resistor 303, and capacitors 302, a second op-amp 401 and variable resistor 402 are used. The variable resistor 402 is used to vary the gain of the second op-amp 401 and therefore vary the amplitude (that is, loudness) of the audio output. The variable resistor 402 may be attached to a knob for human control of volume.

This illustrates one variable-amplitude circuit; other variations may include a microprocessor and/or volume-control buttons (such as one to increase volume and one to decrease volume) or other circuits commonly used and well known in the art.

In the case of either amplifier circuit, additional circuits such as electrostatic discharge (ESD) protection may be added. Circuitry to limit output amplitude, to protect the hearing of listeners, may also be added. Numerous variations in amplifier circuits are possible, known and used in the art, and may be used within the scope and spirit of this patent.

In all cases using an amplifier, a source of power is needed, which is usually a battery. Disposable batteries, such as commonly used alkaline AA or AAA batteries, may be used. Rechargeable batteries, such as lithium-ion, lithium-polymer, and nickel-cadmium, may be used. As noted above, a recharging port 202 may simplify the process of recharging, or the rechargeable battery may be removable.

Numerous variations of the circuits and earphones may be used. For example, the earphones may be attached to a structure that holds the earphones against one's ears and on one's head. All of these variations are within the scope and spirit of the patent.

What is claimed is:

1. A set of earphones, including a plug, that includes one extra jack for the optional attachment of an extra set of earphones.

2. The earphones of claim 1 that include an additional power source and amplifier circuit.

3. The earphones of claim 2 with a rechargeable power source.

4. The earphones of claim 3 with a recharging jack.

5. The earphones of claim 2 with a volume control.

6. The earphones of claim 1 that include additional jacks for the optional attachment of more than one extra set of earphones.

7. A set of earphones, including a plug, that includes a jack means for connecting an optional extra set of earphones.

8. The earphones of claim 7 that include power means and amplifier means.

9. The earphones of claim 8 that have a rechargeable power means.

10. The earphones of claim 9 that have a recharging jack means.

11. The earphones of claim 8 that include volume control means.

12. The earphones of claim 7 wherein the jack means permits the connection of more than one optional extra set of earphones.
